(19) United States
(12) Patent Application Publication
(10) Pub. No.: US 2020/0082275 A1
(43) Pub. Date: Mar. 12, 2020

(54) NEURAL NETWORK ARCHITECTURE SEARCH APPARATUS AND METHOD AND COMPUTER READABLE RECORDING MEDIUM

(71) Applicant: FUJITSU LIMITED, Kanagawa (JP)

(72) Inventors: Li SUN, Beijing (CN); Liuan WANG, Beijing (CN); Jun SUN, Beijing (CN)

(73) Assignee: FUJITSU LIMITED, Kanagawa (JP)

(21) Appl. No.: 16/548,853

(22) Filed: Aug. 23, 2019

(30) Foreign Application Priority Data
Sep. 10, 2018 (CN) 201811052825.2

(51) Int. Cl. G06N 3/10; G06N 3/04; G06N 3/08

(52) U.S. Cl. CPC G06N 3/10; G06N 3/08; G06N 3/0445

(57) ABSTRACT

Disclosed are a neural network architecture search apparatus and method and a computer readable recording medium. The neural network architecture search method comprises: defining a search space used as a set of architecture parameters describing the neural network architecture; performing sampling on the architecture parameters in the search space based on parameters of a control unit, to generate at least one sub-neural network architecture; performing training on each sub-neural network architecture by minimizing a loss function including an inter-class loss and a center loss; calculating a classification accuracy and a feature distribution score, and calculating a reward score of the sub-neural network architecture based on the classification accuracy and the feature distribution score; and feeding back the reward score to the control unit, and causing the parameters of the control unit to be adjusted towards a direction in which the reward scores are larger.

### CROSS-REFERENCE TO RELATED APPLICATION

This application claims the priority benefit of Chinese Patent Application No. 201811052825.2, filed on Sep. 10, 2018 in the China National Intellectual Property Administration, the disclosure of which is incorporated herein in its entirety by reference.

### FIELD OF THE INVENTION

The present disclosure relates to the field of information processing, and particularly to a neural network architecture search apparatus and method and a computer readable recording medium.

### BACKGROUND OF THE INVENTION

Currently, close-set recognition problems have been solved thanks to the development of convolutional neural networks. However, open-set recognition problems are widely existing in real application scenes. For example, face recognition and object recognition are typical open-set recognition problems. Open-set recognition problems have multiple known classes, but also have many unknown classes. Open-set recognition requires neural networks having more generalization than neural networks used in normal close-set recognition tasks. Thus, it is desired to find an easy and efficient way to construct neural networks for open-set recognition problems.

### SUMMARY OF THE INVENTION

A brief summary of the present disclosure is given below to provide a basic understanding of some aspects of the present disclosure. However, it should be understood that the summary is not an exhaustive summary of the present disclosure. It does not intend to define a key or important part of the present disclosure, nor does it intend to limit the scope of the present disclosure. The object of the summary is only to briefly present some concepts about the present disclosure, which serves as a preamble of the more detailed description that follows.

In view of the above-mentioned problems, an object of the present disclosure is to provide a neural network architecture search apparatus and method and a classification apparatus and method which are capable of solving one or more disadvantages in the prior art.

According to an aspect of the present disclosure, there is provided a neural network architecture search apparatus, comprising: a unit for defining search space for neural network architecture, configured to define a search space used as a set of architecture parameters describing the neural network architecture; a control unit configured to perform sampling on the architecture parameters in the search space based on parameters of the control unit, to generate at least one sub-neural network architecture; a training unit configured to, by utilizing all samples in a training set, with respect to each sub-neural network architecture of the at least one sub-neural network architecture, calculate an inter-class loss indicating a separation degree between features of samples of different classes and a center loss indicating an aggregation degree between features of samples of a same class, and to perform training on each sub-neural network architecture by minimizing a loss function including the inter-class loss and the center loss; a reward calculation unit configured to, by utilizing all samples in a validation set, with respect to each sub-neural network architecture having been trained, respectively calculate a classification accuracy and a feature distribution score indicating a compactness degree between features of samples belonging to a same class, and to calculate, based on the classification accuracy and the feature distribution score of each sub-neural network architecture, a reward score of each sub-neural network architecture, and an adjustment unit configured to feed back the reward score to the control unit, and to cause the parameters of the control unit to be adjusted towards a direction in which the reward scores of the at least one sub-neural network architecture are larger, wherein processing in the control unit, the training unit, the reward calculation unit and the adjustment unit are performed iteratively, until a predetermined iteration termination condition is satisfied.

According to another aspect of the present disclosure, there is provided a neural network architecture search method, comprising: a step for defining search space for neural network architecture, of defining a search space used as a set of architecture parameters describing the neural network architecture; a control step of performing sampling on the architecture parameters in the search space based on parameters of a control unit, to generate at least one sub-neural network architecture; a training step of, by utilizing all samples in a training set, with respect to each sub-neural network architecture of the at least one sub-neural network architecture, calculating an inter-class loss indicating a separation degree between features of samples of different classes and a center loss indicating an aggregation degree between features of samples of a same class, and performing training on each sub-neural network architecture by minimizing a loss function including the inter-class loss and the center loss; a reward calculation step of, by utilizing all samples in a validation set, with respect to each sub-neural network architecture having been trained, respectively calculating a classification accuracy and a feature distribution score indicating a compactness degree between features of samples belonging to a same class, and calculating, based on the classification accuracy and the feature distribution score of each sub-neural network architecture, a reward score of each sub-neural network architecture, and an adjustment step of feeding back the reward score to the control unit, and causing the parameters of the control unit to be adjusted towards a direction in which the reward scores of the at least one sub-neural network architecture are larger, wherein processing in the control step, the training step, the reward calculation step and the adjustment step are performed iteratively, until a predetermined iteration termination condition is satisfied.

According to still another aspect of the present disclosure, there is provided a computer readable recording medium having stored thereon a program for causing a computer to perform the following steps: a step for defining search space for neural network architecture, of defining a search space used as a set of architecture parameters describing the neural network architecture; a control step of performing sampling on the architecture parameters in the search space based on parameters of a control unit, to generate at least one sub-neural network architecture; a training step of, by utilizing all samples in a training set, with respect to each sub-neural network architecture of the at least one sub-neural network architecture, calculating an inter-class loss indicating a separation degree between features of samples of different classes and a center loss indicating an aggregation degree between features of samples of a same class, and performing training on each sub-neural network architecture by minimizing a loss function including the inter-class loss and the center loss; a reward calculation step of, by utilizing all samples in a validation set, with respect to each sub-neural network architecture having been trained, respectively calculating a classification accuracy and a feature distribution score indicating a compactness degree between features of samples belonging to a same class, and calculating, based on the classification accuracy and the feature distribution score of each sub-neural network architecture, a reward score of each sub-neural network architecture, and an adjustment step of feeding back the reward score to the control unit, and causing the parameters of the control unit to be adjusted towards a direction in which the reward scores of the at least one sub-neural network architecture are larger, wherein processing in the control step, the training step, the reward calculation step and the adjustment step are performed iteratively, until a predetermined iteration termination condition is satisfied.

According to other aspects of the present disclosure, there is further provided a computer program code and a computer program product for implementing the above-mentioned method according to the present disclosure.

Other aspects of embodiments of the present disclosure will be given in the following specification part, wherein preferred embodiments for sufficiently disclosing embodiments of the present disclosure are described in detail, without applying limitations thereto.

### BRIEF DESCRIPTION OF THE DRAWINGS

The present disclosure can be better understood with reference to the detailed description given in conjunction with the appended drawings below, wherein throughout the drawings, same or similar reference signs are used to represent same or similar components. The appended drawings, together with the detailed description below, are incorporated in the specification and form a part of the specification, to further describe preferred embodiments of the present disclosure and explain the principles and advantages of the present disclosure by way of examples. In the appended drawings:

FIG. 1 is a block diagram of a functional configuration example of a neural network architecture search apparatus according to an embodiment of the present disclosure;

FIG. 2 is a diagram of an example of a neural network architecture according to an embodiment of the present disclosure;

FIGS. 3A through 3C are diagrams showing an example of performing sampling on architecture parameters in a search space by a recurrent neural network RNN-based control unit according to an embodiment of the present disclosure;

FIG. 4 is a diagram showing an example of a structure of a block unit according to an embodiment of the present disclosure;

FIG. 5 is a flowchart showing a flow example of a neural network architecture search method according to an embodiment of the present disclosure; and

FIG. 6 is a block diagram showing an exemplary structure of a personal computer that can be used in an embodiment of the present disclosure.

### EMBODIMENTS OF THE INVENTION

Hereinafter, exemplary embodiments of the present disclosure will be described in detail in conjunction with the appended drawings. For the sake of clarity and conciseness, the specification does not describe all features of actual embodiments. However, it should be understood that in developing any such actual embodiment, many decisions specific to the embodiments must be made, so as to achieve specific objects of a developer; for example, those limitation conditions related to the system and services are met, and these limitation conditions possibly would vary as embodiments are different. In addition, it should also be appreciated that although developing tasks are possibly complicated and time-consuming, such developing tasks are only routine tasks for those skilled in the art benefiting from the contents of the present disclosure.

It should also be noted herein that, to avoid the present disclosure from being obscured due to unnecessary details, only those device structures and/or processing steps closely related to the solution according to the present disclosure are shown in the appended drawings, while omitting other details not closely related to the present disclosure.

Embodiments of the present disclosure will be described in detail in conjunction with the appended drawings below.

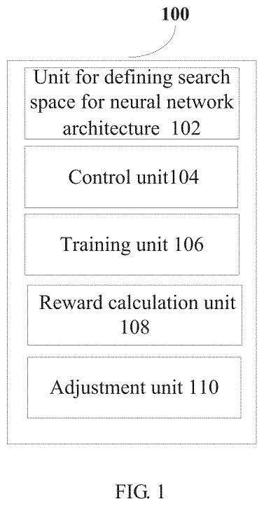

First, a block diagram of a functional configuration example of a neural network architecture search apparatus 100 according to an embodiment of the present disclosure will be described with reference to FIG. 1. FIG. 1 is a block diagram showing the functional configuration example of the neural network architecture search apparatus 100 according to the embodiment of the present disclosure. As shown in FIG. 1, the neural network architecture search apparatus 100 according to the embodiment of the present disclosure comprises a unit for defining search space for neural network architecture 102, a control unit 104, a training unit 106, a reward calculation unit 108, and an adjustment unit 110.

The unit for defining search space for neural network architecture 102 is configured to define a search space used as a set of architecture parameters describing the neural network architecture.

The neural network architecture may be represented by architecture parameters describing the neural network. Taking the simplest convolutional neural network having only convolutional layers as an example, there are five parameters for each convolutional layer: convolutional kernel count, convolutional kernel height, convolutional kernel width, convolutional kernel stride height, and convolutional kernel stride width. Accordingly, each convolutional layer may be represented by the above quintuple set.

The unit for defining search space for neural network architecture 102 according to the embodiment of the present disclosure is configured to define a search space, i.e., to define a complete set of architecture parameters describing the neural network architecture. Unless the complete set of the architecture parameters is determined, an optimal neural network architecture cannot be found from the complete set. As an example, the complete set of the architecture parameters of the neural network architecture may be defined according to experience. Further, the complete set of the architecture parameters of the neural network architecture may also he defined according to a real face recognition database, an object recognition database, etc.

The control unit 104 may be configured to perform sampling on the architecture parameters in the search space based on parameters of the control unit 104, to generate at least one sub-neural network architecture.

If current parameters of the control unit 104 are represented by θ, then the control unit 104 performs sampling on the architecture parameters in the search space based on the parameters θ, to generate at least one sub-neural network architecture. Wherein, the count of the sub-network architectures obtained through the sampling may be set in advance according to actual circumstances.

The training unit 106 may be configured to, by utilizing all samples in a training set, with respect to each sub-neural network architecture of the at least one sub-neural network architecture, calculate an inter-class loss indicating a separation degree between features of samples of different classes and a center loss indicating an aggregation degree between features of samples of a same class, and to perform training on each sub-neural network architecture by minimizing a loss function including the inter-class loss and the center loss.

As an example, the features of the samples may be feature vectors of the samples. The features of the samples may be obtained by employing a common manner in the art, which will not be repeatedly described herein.

As an example, in the training unit 106, a softmax loss may be calculated as an inter-loss Ls of each sub-neural network architecture based on a feature of each sample in the training set. Besides the softmax loss, those skilled in the art can also readily envisage other calculation manners of the inter-class loss, which will not be repeatedly described herein. To make differences between different classes as large as possible, i.e., to separate features of different classes from each other as far as possible, the inter-class loss shall be made as small as possible at the time of performing training on the sub-neural network architectures.

With respect to open-set recognition problems such as face recognition, object recognition and the like, the embodiment of the present disclosure further calculates, for all samples in the training set, with respect to each sub-neural network architecture, a center loss Lc indicating an aggregation degree between features of samples of a same class. As an example, the center loss may be calculated based on a distance between a feature of each sample and a center feature of a class to which the samples belong. To make differences between features of samples belonging to a same class small, i.e., to make features from a same class more aggregative, the center loss shall be made as small as possible at the time of performing training on the sub-neural network architectures.

The loss function L according to the embodiment of the present disclosure may be represented as follows:

L=Ls+ηLc (1)

In the expression (1), η is a hyper-parameter, which can decide which of the inter-class loss Ls and the center loss Lc performs a leading role in the loss function L, and η can be determined according to experience.

The training unit 106 performs training on each sub-neural network architecture with a goal of minimizing the loss function L, thereby making it possible to determine values of architecture parameters of each sub-neural network architecture, i.e., to obtain each sub-neural network architecture having been trained.

Since the training unit 106 performs training on each sub-neural network architecture based on both the inter-class loss and the center loss, features belonging to a same class are made more aggregative while features of samples belonging to different classes are made more separate. Accordingly, it is helpful to more easily judge, in open-set recognition problems, whether an image to be tested belongs to a known class or belongs to an unknown class.

The reward calculation unit 108 may be configured to, by utilizing all samples in a validation set, with respect to each sub-neural network architecture having been trained, respectively calculate a classification accuracy and a feature distribution score indicating a compactness degree between features of samples belonging to a same class, and to calculate, based on the classification accuracy and the feature distribution score of each sub-neural network architecture, a reward score of each sub-neural network architecture.

Preferably, the feature distribution score is calculated based on a center loss indicating an aggregation degree between features of samples of a same class, and the classification accuracy is calculated based on an inter-class loss indicating a separation degree between features of samples of different classes.

It is assumed to represent parameters of one sub-neural network architecture having been trained (i.e., values of architecture parameters of the one sub-neural network architecture) by ω, to represent the classification accuracy of the one sub-neural network architecture as Acc_s(ω), and to represent the feature distribution score thereof as Fd_c(ω). The reward calculation unit 108, by utilizing all the samples in the validation set, with respect to the one sub-neural network architecture, calculates the inter-class loss Ls, and calculates the classification accuracy Acc_s(ω) based on the calculated inter-class loss Ls. Therefore, the classification accuracy Acc_s(ω) may indicate a classification accuracy of performing classification on samples belonging to different classes. Further, the reward calculation unit 108, by utilizing all the samples in the validation set, with respect to the one sub-neural network architecture, calculates the center loss Lc, and calculates the feature distribution score Fd_c(ω) based on the calculated center loss Lc. Therefore, the feature distribution score Fd_c(ω) may indicate a compactness degree between features of samples belonging to a same class,

A reward score R(107 ) of the one sub-neural network architecture is defined as follows:

R(ω)=Acc_s(ω)+ρFd_c(ω) (2)

In the expression (2), ρ is a hyper-parameter. As an example, ρ may be determined according to experience, thereby ensuring the classification accuracy Acc_s(ω) and the feature distribution score Fd_c(ω) to be on a same magnitude level, and ρ can decide which of the classification accuracy Acc_s(ω) and the feature distribution score Fd_c(ω) performs a leading role in the reward score R(ω).

Since the reward calculation unit 108 calculates the reward score based on both the classification accuracy and the feature distribution score, the reward score not only can represent the classification accuracy but also can represent a compactness degree between features of samples belonging to a same class.

The adjustment unit 110 may be configured to feed back the reward score to the control unit, and to cause the parameters of the control unit to be adjusted towards a direction in which the reward scores of the at least one sub-neural network architecture are larger.

For at least one sub-neural network architecture obtained through sampling when parameters of the control unit 104 are 0, one set of reward scores is obtained based on a reward score of each sub-neural network architecture, the one set of reward scores being represented as R′(ω). E_{P(A)}[R′(ω)] represents an expectation of R′(ω). Our goal is to adjust the parameters θ of the control unit 104 under a certain optimization policy P(θ), so as to maximize an expected value of R′(ω). As an example, in a case where only a single sub-neural network architecture is obtained through sampling, our goal is to adjust the parameters θ of the control unit 104 under a certain optimization policy P(θ), so as to maximize a reward score of the single sub-neural network architecture.

As an example, a common optimization policy in reinforcement learning may be used to perform optimization. For example, Proximal Policy Optimization or Gradient Policy Optimization may be used.

As an example, the parameters θ of the control unit 104 are caused to be adjusted towards a direction in which the expected values of the one set of reward scores of the at least one sub-neural network architecture are larger. As an example, adjusted parameters of the control unit 104 may be generated based on the one set of reward scores and the current parameter θ of the control unit 104.

As stated above, the reward score not only can represent the classification accuracy but also can represent a compactness degree between features of samples belonging to a same class. The adjustment unit 110 according to the embodiment of the present disclosure adjusts the parameters of the control unit according to the above reward scores, such that the control unit can obtain sub-neural network architecture(s) making the reward scores larger through sampling based on adjusted parameters; thus, with respect to open-set recognition problems, a neural network architecture more suitable for the open set can be obtained through searching.

In the neural network architecture search apparatus 100 according to the embodiment of the present disclosure, processing in the control unit 104, the training unit 106, the reward calculation unit 108 and the adjustment unit 110 are performed iteratively, until a predetermined iteration termination condition is satisfied.

As an example, in each subsequent round of iteration, the control unit 104 re-performs sampling on the architecture parameters in the search space according to adjusted parameters thereof, to re-generate at least one sub-neural network architecture. The training unit 106 performs training on each re-generated sub-neural network architecture, the reward calculation unit 108 calculates a reward score of each sub-neural network architecture having been trained, and then the adjustment unit 110 feeds back the reward score to the control unit 104, and causes the parameters of the control unit 104 to be re-adjusted towards a direction in which the one set of reward scores of the at least one sub-neural network architecture are larger.

As an example, an iteration termination condition is that the performance of the least one sub-neural network architecture is good enough (for example, the one set of reward scores of the at least one sub-neural network architecture satisfy a predetermined condition) or a maximum iteration number is reached.

To sum up, the neural network architecture search apparatus 100 according to the embodiment of the present disclosure is capable of, by iteratively performing processing in the control unit 104, the training unit 106, the reward calculation unit 108 and the adjustment unit 110, with respect to a certain actual open-set recognition problem, automatically obtaining a neural network architecture suitable for the open set through searching by utilizing part of supervised data (samples in a training set and samples in a validation set) having been available, thereby making it possible to easily and efficiently construct a neural network architecture having stronger generalization for the open-set recognition problem.

Preferably, to better solve open-set recognition problems so as to make it possible to search for a neural network architecture more suitable for the open set, the unit for defining search space for neural network architecture 102 may be configured to define the search space for open-set recognition.

Preferably, the unit for defining search space for neural network architecture 102 may be configured to define the neural network architecture as including a predetermined number of block units for performing transformation on features of samples and the predetermined number of feature integration layers for performing integration on the features of the samples which are arranged in series, wherein one of the feature integration layers is arranged downstream of each block unit, and the unit for defining search space for neural network architecture 102 may be configured to define a structure of each feature integration layer of the predetermined number of feature integration layers in advance, and the control unit 104 may be configured to perform sampling on the architecture parameters in the search space, to form each block unit of the predetermined number of block units, so as to generate each sub-neural network architecture of the at least one sub-neural network architecture.

As an example, the neural network architecture may be defined according to a real face recognition database, an object recognition database, etc.

As an example, the feature integration layers may be convolutional layers.

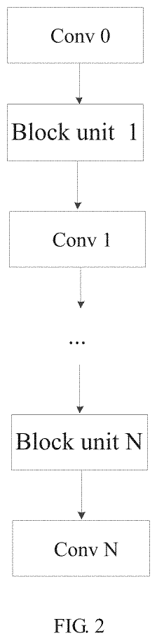

FIG. 2 is a diagram of an example of a neural network architecture according to an embodiment of the present disclosure. The unit for defining search space for neural network architecture 102 defines the structure of each of N feature integration layers as being a convolutional layer in advance. As shown in FIG. 2, the neural network architecture has a feature extraction layer (i.e., convolutional layer Conv 0), which is used for extracting features of an inputted image. Further, the neural network architecture has N block units (block unit 1, . . . , block unit N) and N feature integration layers (i.e., convolutional layers Conv 1, . . . , Conv N) which are arranged in series, wherein one feature integration layer is arranged downstream of each block unit, where N is an integer greater than or equal to 1.

Each block unit may comprise M layers formed by any combination of several operations. Each block unit is used for performing processing such as transformation and the like on features of images through operations incorporated therein. Wherein, M may be determined in advance according to the complexity of tasks to be processed, where M is an integer greater than or equal to 1. The specific structures of the N block units will be determined through the searching (specifically, the sampling performed on the architecture parameters in the search space by the control unit 104 based on parameters thereof) performed by the neural network architecture search apparatus 100 according to the embodiment of the present disclosure, that is, it will be determined which operations are specifically incorporated in the N block units. After the structures of the N block units are determined through the searching, a specific neural network architecture (more specifically, a sub-neural network architecture obtained through sampling) can be obtained.

Preferably, the set of architecture parameters comprises any combination of 3×3 convolutional kernel, 5×5 convolutional kernel, 3×3 depthwise separate convolution, 5×5 depthwise separate convolution, 3×3 Max pool, 3×3 Avg pool, Identity residual skip, Identity residual no skip. As an example, the above any combination of 3×3 convolutional kernel, 5×5 convolutional kernel, 3×3 depthwise separate convolution, 5×5 depthwise separate convolution, 3×3 Max pool, 3×3 Avg pool, Identity residual skip, Identity residual no skip may be used as an operation incorporated in each layer in the above N block units. The above set of architecture parameters is more suitable for solving open-set recognition problems.

The set of architecture parameters is not limited to the above operations. As an example, the set of architecture parameters may further comprise 1×1 convolutional kernel, 7×7 convolutional kernel, 1×1 depthwise separate convolution, 7×7 depthwise separate convolution, 1×1 Max pool, 5×5 Max pool, 1×1 Avg pool, 5×5 Avg pool. etc.

Preferably, the control unit may include a recurrent neural network RNN. Adjusted parameters of the control unit including the RNN may be generated based on the reward scores and the current parameter of the control unit including the RNN.

The count of the sub-neural network architectures obtained through sampling is related to a length input dimension of the RNN. Hereinafter, for the sake of clarity, the control unit 104 including the RNN is referred to as an RNN-based control unit 104.

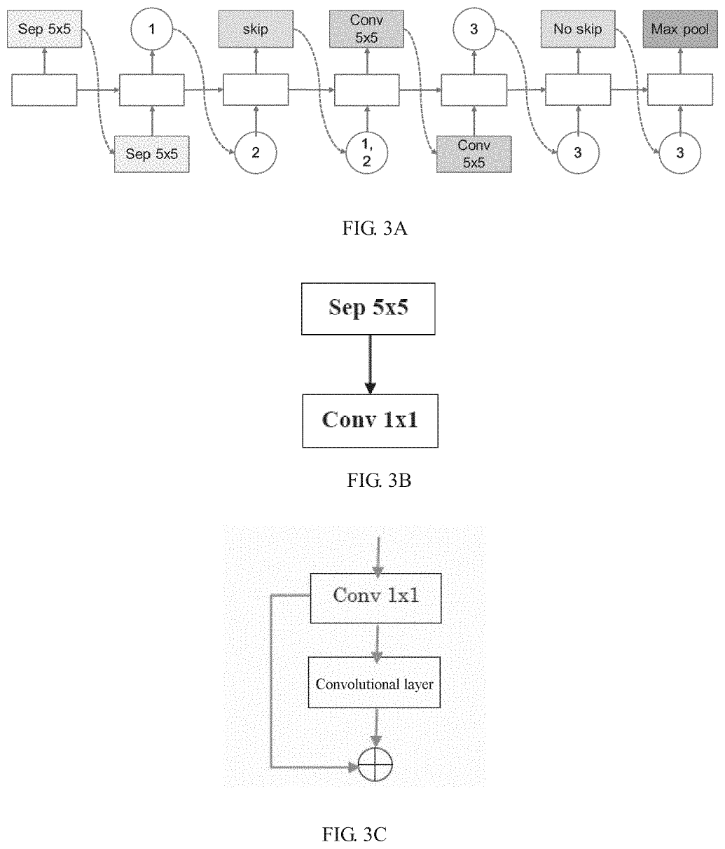

FIGS. 3a through 3c are diagrams showing an example of performing sampling on architecture parameters in a search space by an RNN-based control unit 104 according to an embodiment of the present disclosure.

In the description below, for the convenience of representation, the 5×5 depthwise separate convolution is represented by Sep 5×5, the identity residual skip is represented by skip, the 1×1 convolution is represented by Conv 1×1, the 5×5 convolutional kernel is represented by Conv 5×5, the Identity residual no skip is represented by No skip, and the Max pool is represented by Max pool.

As can be seen from FIG. 3a, based on parameters of the RNN-based control unit 104, an operation obtained by a first step of RNN sampling is Sep 5×5, its basic structure is as shown in FIG. 3b, and it is marked as “1” in FIG. 3a.

As can be seen from FIG. 3a, an operation of a second step which can be obtained according to the value obtained by the first step of RNN sampling and parameters of a second step of RNN sampling is skip, its basic structure is as shown in FIG. 3c, and it is marked as “2” in FIG. 3a.

Next, an operation obtained by a third step of RNN in FIG. 3a is Conv 5×5, wherein an input of Conv 5×5 is a combination of “1” and “2” in FIG. 3a (schematically shown by “1, 2” in a circle in FIG. 3a).

An operation of a fourth step of RNN sampling in FIG. 3a is no skip, and it needs no operation and is not marked.

An operation of a fifth step of RNN sampling in FIG. 3a is max pool, and it is sequentially marked as “4” (already omitted in the figure).

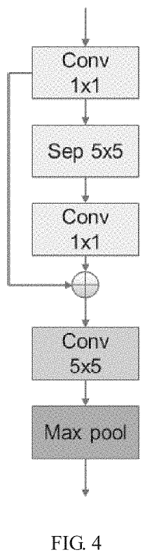

According to the sampling performed on the architecture parameters in the search space by the RNN-based control unit 104 as shown in FIG. 3a, the specific structure of the block unit as shown in FIG. 4 can be obtained. FIG. 4 is a diagram showing an example of a structure of a block unit according to an embodiment of the present disclosure. As shown in FIG. 4, in the block unit, operations Conv 1×1, Sep 5×5, Conv 5×5 and Max pool are incorporated.

By filling the obtained specific structures of the block units into the block units in the neural network architecture as shown in FIG. 2, a sub-neural network architecture can be generated, that is, a specific structure of a neural network architecture according to the embodiment of the present disclosure (more specifically, a sub-neural network architecture obtained through sampling) can be obtained. As an example, assuming that the structures of the N block units are the same, a sub-neural network architecture can be generated by filling the specific structure of the block unit as shown in FIG. 4 into each block unit in the neural network architecture as shown in FIG. 2,

Preferably, the at least one sub-neural network architecture obtained at the time of iteration termination is used for open-set recognition. As an example, the at least one sub-neural network architecture obtained at the time of iteration termination may be used for open-set recognition such as face image recognition, object recognition and the like.

Corresponding to the above-mentioned embodiment of the neural network architecture search apparatus, the present disclosure further provides the following embodiment of a neural network architecture search method.

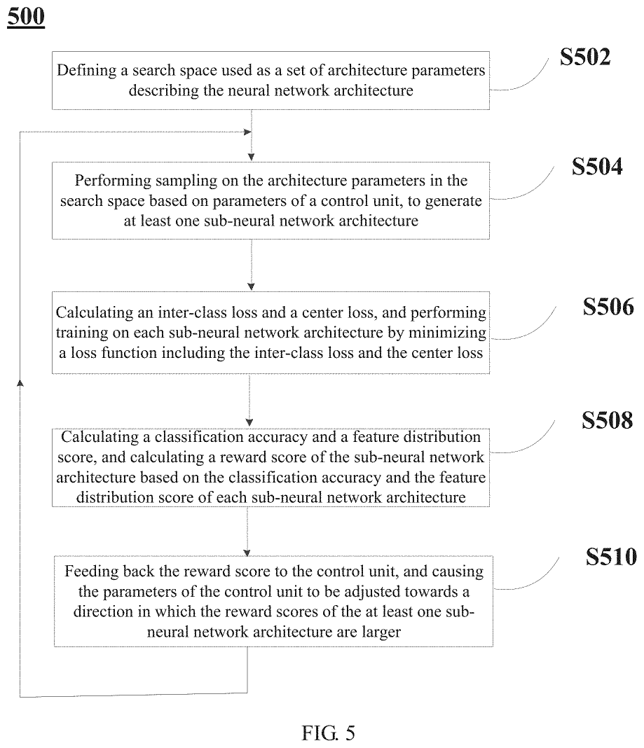

FIG. 5 is a flowchart showing a flow example of a neural network architecture search method 500 according to an embodiment of the present disclosure.

As shown in FIG. 5, the neural network architecture search method 500 according to the embodiment of the present disclosure comprises a step for defining search space for neural network architecture S502, a control step S504, a training step S506, a reward calculation step S508, and an adjustment step S510.

in the step for defining search space for neural network architecture S502, a search space used as a set of architecture parameters describing the neural network architecture is defined.

The neural network architecture may be represented by the architecture parameters describing the neural network architecture. As an example, a complete set of the architecture parameters of the neural network architecture may be defined according to experience. Further, a complete set of the architecture parameters of the neural network architecture may also be defined according to a real face recognition database, an object recognition database, etc.

In the control step S504, sampling is performed on the architecture parameters in the search space based on parameters of a control unit, to generate at least one sub-neural network architecture. Wherein, the count of the sub-network architectures obtained through the sampling may be set in advance according to actual circumstances.

In the training step S506, by utilizing all samples in a training set, with respect to each sub-neural network architecture of the at least one sub-neural network architecture, an inter-class loss indicating a separation degree between features of samples of different classes and a center loss indicating an aggregation degree between features of samples of a same class are calculated, and training is performed on each sub-neural network architecture by minimizing a loss function including the inter-class loss and the center loss.

As an example, the features of the samples may be feature vectors of the samples.

For specific examples of calculating the inter-class loss and the center loss, reference may be made to the description in the corresponding portions (for example about the training unit 106) in the above-mentioned apparatus embodiment, and no repeated description will be made herein.

Since training is performed on each sub-neural network architecture based on both the inter-class loss and the center loss in the training step S506, features belonging to a same class are made more aggregative while features of samples belonging to different classes are made more separate. Accordingly, it is helpful to more easily judge, in open-set recognition problems, whether an image to be tested belongs to a known class or belongs to an unknown class.

In the reward calculation step S508, by utilizing all samples in a validation set, with respect to each sub-neural network architecture having been trained, a classification accuracy and a feature distribution score indicating a compactness degree between features of samples belonging to a same class are respectively calculated, and a reward score of the sub-neural network architecture is calculated based on the classification accuracy and the feature distribution score of each sub-neural network architecture.

Preferably, the feature distribution score is calculated based on the center loss indicating the aggregation degree between features of samples of a same class, and the classification accuracy is calculated based on the inter-class loss indicating the separation degree between features of samples of different classes.

For specific examples of calculating the classification accuracy, the feature distribution score and the reward score, reference may be made to the description in the corresponding portions (for example about the calculation unit 108) in the above-mentioned apparatus embodiment, and no repeated description will be made herein.

Since the reward score is calculated based on both the classification accuracy and the feature distribution score in the reward calculation step S508, the reward score not only can represent the classification accuracy but also can represent a compactness degree between features of samples belonging to a same class.

In the adjustment step S510, the reward score is fed back to the control unit, and the parameters of the control unit are caused to be adjusted towards a direction in which the reward scores of the at least one sub-neural network architecture are larger.

For specific example of causing the parameters of the control unit to be adjusted towards a direction in which the reward scores of the at least one sub-neural network architecture are larger, reference may be made to the description in the corresponding portion (for example about the adjustment unit 110) in the above-mentioned apparatus embodiment, and no repeated description will be made herein.

As stated above, the reward score not only can represent the classification accuracy but also can represent a compactness degree between features of samples belonging to a same class. In the adjustment step S510, the parameters of the control unit are adjusted according to the above reward scores, such that the control unit can obtain sub-neural network architectures making the reward scores larger through sampling based on adjusted parameters thereof; thus, with respect to open-set recognition problems, a neural network architecture more suitable for the open set can be obtained through searching.

In the neural network architecture search method 500 according to the embodiment of the present disclosure, processing in the control step S504, the training step S506, the reward calculation step S508 and the adjustment step S510 are performed iteratively, until a predetermined iteration termination condition is satisfied.

For specific example of the iterative processing, reference may be made to the description in the corresponding portions in the above-mentioned apparatus embodiment, and no repeated description will be made herein.

To sum up, the neural network architecture search method 500 according to the embodiment of the present disclosure is capable of, by iteratively performing the control step S504, the training step S506, the reward calculation step S508 and the adjustment step S510, with respect to a certain actual open-set recognition problem, automatically obtaining a neural network architecture suitable for the open set through searching by utilizing part of supervised data (samples in a training set and samples in a validation set) having been available, thereby making it possible to easily and efficiently construct a neural network architecture having stronger generalization for the open-set recognition problem.

Preferably, to better solve open-set recognition problems so as to make it possible to obtain neural network architecture(s) more suitable for the open set, the search space is defined for open-set recognition in the step for defining search space for neural network architecture S502.

Preferably, in the step for defining search space for neural network architecture S502, the neural network architecture is defined as including a predetermined number of block units for performing transformation on features of samples and the predetermined number of feature integration layers for performing integration on the features of the samples which are arranged in series, wherein one of the feature integration layers is arranged downstream of each block unit, and in the step for defining search space for neural network architecture S502, a structure of each feature integration layer of the predetermined number of feature integration layers is defined in advance, and in the control step S504, sampling is performed on the architecture parameters in the search space based on parameters of the control unit, to form each block unit of the predetermined number of block units, so as to generate each sub-neural network architecture of the at least one sub-neural network architecture.

As an example, the neural network architecture may be defined according to a real face recognition database, an object recognition database, etc.

For specific examples of the block unit and the neural network architecture, reference may be made to the description in the corresponding portions (for example FIG. 2 and FIGS. 3a through FIG. 3c) in the above-mentioned apparatus embodiment, and no repeated description will be made herein.

Preferably, the set of architecture parameters comprises any combination of 3×3 convolutional kernel, 5×5 convolutional kernel, 3×3 depthwise separate convolution, 5×5 depthwise separate convolution, 3×3 Max pool, 3×3 Avg pool, Identity residual skip, Identity residual no skip. As an example, the above any combination of 3×3 convolutional kernel, 5×5 convolutional kernel, 3×3 depthwise separate convolution, 5×5 depthwise separate convolution, 3×3 Max pool, 3×3 Avg pool, Identity residual skip, Identity residual no skip may be used as an operation incorporated in each layer in the block units.

The set of architecture parameters is not limited to the above operations. As an example, the set of architecture parameters may further comprise 1×1 convolutional kernel, 7×7 convolutional kernel, 1×1 depthwise separate convolution, 7×7 depthwise separate convolution, 1×1 Max pool, 5×5 Max pool, 1×1 Avg pool, 5×5 Avg pool, etc.

Preferably, the at least one sub-neural network architecture obtained at the time of iteration termination is used for open-set recognition. As an example, the at least one sub-neural network architecture obtained at the time of iteration termination may be used for open-set recognition such as face image recognition, object recognition and the like.

It should be noted that, although the functional configuration of the neural network architecture search apparatus according to the embodiment of the present disclosure has been described above, this is only exemplary but not limiting, and those skilled in the art can carry out modifications on the above embodiment according to the principle of the disclosure, for example can perform additions, deletions or combinations or the like on the respective functional modules in the embodiment. Moreover, all such modifications fall within the scope of the present disclosure.

Further, it should also be noted that the apparatus embodiment herein corresponds to the above method embodiment. Thus for contents not described in detail in the apparatus embodiment, reference may be made to the description in the corresponding portions in the method embodiment, and no repeated description will be made herein.

Further, the present disclosure further provides a storage medium and a program product. Machine executable instructions in the storage medium and the program product according to embodiments of the present disclosure may be configured to implement the above neural network architecture search method. Thus for contents not described in detail herein, reference may be made to the description in the preceding corresponding portions, and no repeated description will be made herein.

Accordingly, a storage medium for carrying the above program product comprising machine executable instructions is also included in the disclosure of the present invention. The storage medium includes but is not limited to a floppy disc, an optical disc, a magnetic optical disc, a memory card, a memory stick and the like.

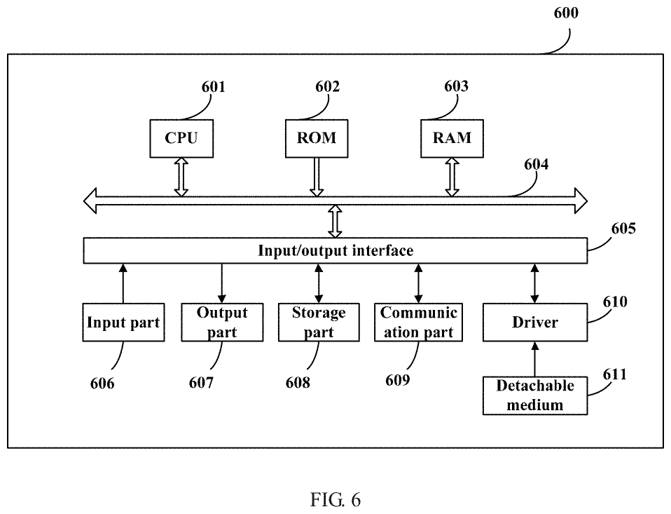

In addition, it should also be noted that, the foregoing series of processing and apparatuses can also be implemented by software and/or firmware. In the case of implementation by software and/or firmware, programs constituting the software are installed from a storage medium or a network to a computer having a dedicated hardware structure, for example the universal personal computer 600 as shown in FIG. 6. The computer, when installed with various programs, can execute various functions and the like.

In FIG. 6, a Central Processing Unit (CPU) 601 executes various processing according to programs stored in a Read-Only Memory (ROM) 602 or programs loaded from a storage part 608 to a Random Access Memory (RAM) 603. In the RAM 603, data needed when the CPU 601 executes various processing and the like is also stored, as needed.

The CPU 601. the ROM 602 and the RAM 603 are connected to each other via a bus 604. An input/output interface 605 is also connected to the bus 604.

The following components are connected to the input/output interface 605: an input part 606, including a keyboard, a mouse and the like; an output part 607, including a display, such as a Cathode Ray Tube (CRT), a Liquid Crystal Display (LCD) and the like, as well as a speaker and the like; the storage part 608, including a hard disc and the like; and a communication part 609, including a network interface card such as an LAN card, a modem and the like. The communication part 609 executes communication processing via a network such as the Internet.

As needed, a driver 610 is also connected to the input/output interface 605. A detachable medium 611 such as a magnetic disc, an optical disc, a magnetic optical disc, a semiconductor memory and the like is installed on the driver 610 as needed, such that computer programs read therefrom are installed in the storage part 608 as needed.

In a case where the foregoing series of processing is implemented by software, programs constituting the software are installed from a network such as the Internet or a storage medium such as the detachable medium 611.

Those skilled in the art should appreciate that, such a storage medium is not limited to the detachable medium 611 in Which programs are stored and which are distributed separately from an apparatus to provide the programs to users as shown in FIG. 6. Examples of the detachable medium 611 include a magnetic disc (including a floppy disc (registered trademark)), a compact disc (including a Compact Disc Read-Only Memory (CD-ROM) and a Digital Versatile Disc (DVD), a magneto optical disc (including a Mini Disc (MD) (registered trademark)), and a semiconductor memory. Alternatively, the memory medium may be hard discs included in the ROM 602 and the memory part 608, in which programs are stored and which are distributed together with the apparatus containing them to users.

Preferred embodiments of the present disclosure have been described above with reference to the drawings. However, the present disclosure of course is not limited to the above examples. Those skilled in the art can obtain various alterations and modifications within the scope of the appended claims, and it should be understood that these alterations and modifications naturally will fall within the technical scope of the present disclosure.

For example, in the above embodiments, a plurality of functions incorporated in one unit can be implemented by separate devices. Alternatively, in the above embodiments, a plurality of functions implemented by a plurality of units can be implemented by separate devices, respectively. In addition, one of the above functions can be implemented by a plurality of units. Undoubtedly, such configuration is included within the technical scope of the present disclosure.

In the specification, the steps described in the flowcharts not only include processing executed in the order according to a time sequence, but also include processing executed in parallel or separately but not necessarily according to a time sequence. Further, even in the steps of the processing according to a time sequence, it is undoubtedly still possible to appropriately change the order.

In addition, the following configurations may also be performed according to the technology of the present disclosure.

Appendix 1, A neural network architecture search apparatus, comprising:

a unit for defining search space for neural network architecture, configured to define a search space used as a set of architecture parameters describing the neural network architecture

a control unit configured to perform sampling on the architecture parameters in the search space based on parameters of the control unit, to generate at least one sub-neural network architecture:

a training unit configured to, by utilizing all samples in a training set, with respect to each sub-neural network architecture of the at least one sub-neural network architecture, calculate an inter-class loss indicating a separation degree between features of samples of different classes and a center loss indicating an aggregation degree between features of samples of a same class, and to perform training on each sub-neural network architecture by minimizing a loss function including the inter-class loss and the center loss;

a reward calculation unit configured to, by utilizing all samples in a validation set, with respect to each sub-neural network architecture having been trained, respectively calculate a classification accuracy and a feature distribution score indicating a compactness degree between features of samples belonging to a same class, and to calculate, based on the classification accuracy and the feature distribution score of each sub-neural network architecture, a reward score of each sub-neural network architecture, and

an adjustment unit configured to feed back the reward score to the control unit, and to cause the parameters of the control unit to be adjusted towards a direction in which the reward scores of the at least one sub-neural network architecture are larger,

wherein processing in the control unit, the training unit, the reward calculation unit and the adjustment unit are performed iteratively, until a predetermined iteration termination condition is satisfied

Appendix 2. The neural network architecture search apparatus according to Appendix 1, wherein the unit for defining search space for neural network architecture is configured to define the search space for open-set recognition.

Appendix 3. The neural network architecture search apparatus according to Appendix 2, wherein

the unit for defining search space for neural network architecture is configured to define the neural network architecture as including a predetermined number of block units for performing transformation on features of samples and the predetermined number of feature integration layers for performing integration on the features of the samples which are arranged in series, and is configured to define a structure of each feature integration layer of the predetermined number of feature integration layers in advance, wherein one of the feature integration layers is arranged downstream of each block unit; and

the control unit is configured to perform sampling on the architecture parameters in the search space, to form each block unit of the predetermined number of block units, so as to generate each sub-neural network architecture of the at least one sub-neural network architecture.

Appendix 4. The neural network architecture search apparatus according to Appendix 1, wherein

the feature distribution score is calculated based on a center loss indicating an aggregation degree between features of samples of a same class; and

the classification accuracy is calculated based on an inter-class loss indicating a separation degree between features of samples of different classes.

Appendix 5. The neural network architecture search apparatus according to Appendix 1, wherein the set of architecture parameters comprises any combination of 3×3 convolutional kernel, 5×5 convolutional kernel, 3×3 depthwise separate convolution, 5×5 depthwise separate convolution. 3×3 Max pool. 3×3 Avg pool, Identity residual skip. Identity residual no skip.

Appendix 6. The neural network architecture search apparatus according to Appendix 1, wherein the at least one sub-neural network architecture obtained at the time of iteration termination is used for open-set recognition.

Appendix 7. The neural network architecture search apparatus according to Appendix 1, wherein the control unit includes a recurrent neural network.

Appendix 8. A neural network architecture search method, comprising:

a step for defining search space for neural network architecture, of defining a search space used as a set of architecture parameters describing the neural network architecture;

a control step of performing sampling on the architecture parameters in the search space based on parameters of a control unit, to generate at least one sub-neural network architecture;

a training step of, by utilizing all samples in a training set, with respect to each sub-neural network architecture of the at least one sub-neural network architecture, calculating an inter-class loss indicating a separation degree between features of samples of different classes and a center loss indicating an aggregation degree between features of samples of a same class, and performing training on each sub-neural network architecture by minimizing a loss function including the inter-class loss and the center loss;

a reward calculation step of, by utilizing all samples in a validation set, with respect to each sub-neural network architecture having been trained, respectively calculating a classification accuracy and a feature distribution score indicating a compactness degree between features of samples belonging to a same class, and calculating, based on the classification accuracy and the feature distribution score of each sub-neural network architecture, a reward score of each sub-neural network architecture, and

an adjustment step of feeding back the reward score to the control unit, and causing the parameters of the control unit to be adjusted towards a direction in which the reward scores of the at least one sub-neural network architecture are larger,

wherein processing in the control step, the training step, the reward calculation step and the adjustment step are performed iteratively, until a predetermined iteration termination condition is satisfied.

Appendix 9. The neural network architecture search method according to Appendix 8, wherein in the step for defining search space for neural network architecture, the search space is defined for open-set recognition.

Appendix 10. The neural network architecture search method according to Appendix 9, wherein

in the step for defining search space for neural network architecture, the neural network architecture is defined as including a predetermined number of block units for performing transformation on features of samples and the predetermined number of feature integration layers for performing integration on the features of the samples which are arranged in series, wherein one of the feature integration layers is arranged downstream of each block unit, and in the step for defining search space for neural network architecture, a structure of each feature integration layer of the predetermined number of feature integration layers is defined in advance, and

in the control step, sampling is performed on the architecture parameters in the search space based on parameters of the control unit, to form each block unit of the predetermined number of block units, so as to generate each sub-neural network architecture of the at least one sub-neural network architecture.

Appendix 11. The neural network architecture search method according to Appendix 8, wherein

the feature distribution score is calculated based on a center loss indicating a aggregation degree between features of samples of a same class; and

the classification accuracy is calculated based on an inter-class loss indicating a separation degree between features of samples of different classes.

Appendix 12. The neural network architecture search method according to Appendix 8, wherein the set of architecture parameters comprises any combination of 3×3 convolutional kernel, 5×5 convolutional kernel, 3×3 depthwise separate convolution, 5×5 depthwise separate convolution, 3×3 Max pool, 3×3 Avg pool. Identity residual skip, Identity residual no skip.

Appendix 13. The neural network architecture search method according to Appendix 8, wherein the at least one sub-neural network architecture obtained at the time of iteration termination is used for open-set recognition.

Appendix 14. A computer readable recording medium having stored thereon a program for causing a computer to perform the following steps:

a step for defining search space for neural network architecture, of defining a search space used as a set of architecture parameters describing the neural network architecture;

a control step of performing sampling on the architecture parameters in the search space based on parameters of a control unit, to generate at least one sub-neural network architecture;

a training step of, by utilizing all samples in a training set, with respect to each sub-neural network architecture of the at least one sub-neural network architecture, calculating an inter-class loss indicating a separation degree between features of samples of different classes and a center loss indicating an aggregation degree between features of samples of a same class, and performing training on each sub-neural network architecture by minimizing a loss function including the inter-class loss and the center loss;

a reward calculation step of, by utilizing all samples in a validation set, with respect to each sub-neural network architecture having been trained, respectively calculating a classification accuracy and a feature distribution score indicating a compactness degree between features of samples belonging to a same class, and calculating, based on the classification accuracy and the feature distribution score of each sub-neural network architecture, a reward score of each sub-neural network architecture, and

an adjustment step of feeding back the reward score to the control unit, and causing the parameters of the control unit to be adjusted towards a direction in which the reward scores of the at least one sub-neural network architecture are larger,

wherein processing in the control step, the training step, the reward calculation step and the adjustment step are performed iteratively, until a predetermined iteration termination condition is satisfied.

1. A neural network architecture search apparatus, comprising:
a unit for defining search space for neural network architecture, configured to define a search space used as a set of architecture parameters describing the neural network architecture;
a control unit configured to perform sampling on the architecture parameters in the search space based on parameters of the control unit, to generate at least one sub-neural network architecture;
a training unit configured to, by utilizing all samples in a training set, with respect to each sub-neural network architecture of the at least one sub-neural network architecture, calculate an inter-class loss indicating a separation degree between features of samples of different classes and a center loss indicating an aggregation degree between features of samples of a same class, and to perform training on each sub-neural network architecture by minimizing a loss function including the inter-class loss and the center loss;
a reward calculation unit configured to, by utilizing all samples in a validation set, with respect to each sub-neural network architecture having been trained, respectively calculate a classification accuracy and a feature distribution score indicating a compactness degree between features of samples belonging to a same class, and to calculate, based on the classification accuracy and the feature distribution score of each sub-neural network architecture, a reward score of each sub-neural network architecture, and
an adjustment unit configured to feed back the reward score to the control unit, and to cause the parameters of the control unit to be adjusted towards a direction in which the reward scores of the at least one sub-neural network architecture are larger,
wherein processing in the control unit, the training unit, the reward calculation unit and the adjustment unit are performed iteratively, until a predetermined iteration termination condition is satisfied.

2. The neural network architecture search apparatus according to claim 1, wherein the unit for defining search space for neural network architecture is configured to define the search space for open-set recognition.

3. The neural network architecture search apparatus according to claim 2, wherein
the unit for defining search space for neural network architecture is configured to define the neural network architecture as including a predetermined number of block units for performing transformation on features of samples and the predetermined number of feature integration layers for performing integration on the features of the samples which are arranged in series, and is configured to define a structure of each feature integration layer of the predetermined number of feature integration layers in advance, wherein one of the feature integration layers is arranged downstream of each block unit; and
the control unit is configured to perform sampling on the architecture parameters in the search space, to form each block unit of the predetermined number of block units, so as to generate each sub-neural network architecture of the at least one sub-neural network architecture.

4. The neural network architecture search apparatus according to claim 1, wherein
the feature distribution score is calculated based on a center loss indicating an aggregation degree between features of samples of a same class; and
the classification accuracy is calculated based on an inter-class loss indicating a separation degree between features of samples of different classes.

5. The neural network architecture search apparatus according to claim 1, wherein the set of architecture parameters comprises any combination of 3×3 convolutional kernel, 5×5 convolutional kernel, 3×3 depthwise separate convolution, 5×5 depthwise separate convolution, 3×3 Max pool, 3×3 Avg pool, Identity residual skip, Identity residual no skip.

6. The neural network architecture search apparatus according to claim 1, wherein the at least one sub-neural network architecture obtained at the time of iteration termination is used for open-set recognition.

7. The neural network architecture search apparatus according to claim 1, wherein the control unit includes a recurrent neural network.

8. A neural network architecture search method, comprising:
a step for defining search space for neural network architecture, of defining a search space used as a set of architecture parameters describing the neural network architecture;
a control step of performing sampling on the architecture parameters in the search space based on parameters of a control unit, to generate at least one sub-neural network architecture;
a training step of, by utilizing all samples in a training set, with respect to each sub-neural network architecture of the at least one sub-neural network architecture, calculating an inter-class loss indicating a separation degree between features of samples of different classes and a center loss indicating an aggregation degree between features of samples of a same class, and performing training on each sub-neural network architecture by minimizing a loss function including the inter-class loss and the center loss;
a reward calculation step of, by utilizing all samples in a validation set, with respect to each sub-neural network architecture having been trained, respectively calculating a classification accuracy and a feature distribution score indicating a compactness degree between features of samples belonging to a same class, and calculating, based on the classification accuracy and the feature distribution score of each sub-neural network architecture, a reward score of each sub-neural network architecture, and
an adjustment step of feeding back the reward score to the control unit, and causing the parameters of the control unit to be adjusted towards a direction in which the reward scores of the at least one sub-neural network architecture are larger,
wherein processing in the control step, the training step, the reward calculation step and the adjustment step are performed iteratively, until a predetermined iteration termination condition is satisfied.

9. The neural network architecture search method according to claim 8, wherein in the step for defining search space for neural network architecture, the search space is defined for open-set recognition.

10. The neural network architecture search method according to claim 9, wherein
in the step for defining search space for neural network architecture, the neural network architecture is defined as including a predetermined number of block units for performing transformation on features of samples and the predetermined number of feature integration layers for performing integration on the features of the samples which are arranged in series, wherein one of the feature integration layers is arranged downstream of each block unit, and in the step for defining search space for neural network architecture, a structure of each feature integration layer of the predetermined number of feature integration layers is defined in advance, and
in the control step, sampling is performed on the architecture parameters in the search space based on parameters of the control unit, to form each block unit of the predetermined number of block units, so as to generate each sub-neural network architecture of the at least one sub-neural network architecture.

11. The neural network architecture search method according to claim 8, wherein
the feature distribution score is calculated based on a center loss indicating an aggregation degree between features of samples of a same class; and
the classification accuracy is calculated based on an inter-class loss indicating a separation degree between features of samples of different classes.

12. The neural network architecture search method according to claim 8, wherein the set of architecture parameters comprises any combination of 3×3 convolutional kernel, 5×5 convolutional kernel, 3×3 depthwise separate convolution, 5×5 depthwise separate convolution, 3×3 Max pool, 3×3 Avg pool, Identity residual skip, Identity residual no skip.

13. The neural network architecture search method according to claim 8, wherein the at least one sub-neural network architecture obtained at the time of iteration termination is used for open-set recognition.

14. A computer readable recording medium having stored thereon a program for causing a computer to perform the following steps:
a step for defining search space for neural network architecture, of defining a search space used as a set of architecture parameters describing the neural network architecture;
a control step of performing sampling on the architecture parameters in the search space based on parameters of a control unit, to generate at least one sub-neural network architecture;
a training step of, by utilizing all samples in a training set, with respect to each sub-neural network architecture of the at least one sub-neural network architecture, calculating an inter-class loss indicating a separation degree between features of samples of different classes and a center loss indicating an aggregation degree between features of samples of a same class, and performing training on each sub-neural network architecture by minimizing a loss function including the inter-class loss and the center loss;
a reward calculation step of, by utilizing all samples in a validation set, with respect to each sub-neural network architecture having been trained, respectively calculating a classification accuracy and a feature distribution score indicating a compactness degree between features of samples belonging to a same class, and calculating, based on the classification accuracy and the feature distribution score of each sub-neural network architecture, a reward score of each sub-neural network architecture, and
an adjustment step of feeding back the reward score to the control unit, and causing the parameters of the control unit to be adjusted towards a direction in which the reward scores of the at least one sub-neural network architecture are larger,
wherein processing in the control step, the training step, the reward calculation step and the adjustment step are performed iteratively, until a predetermined iteration termination condition is satisfied.
